(19) United States
(12) Patent Application Publication
(10) Pub. No.: US 2010/0018850 A1
(43) Pub. Date: Jan. 28, 2010

(54) System for removing particulate matter from exhaust streams

(75) Inventors: Atanu Adhvaryu, Peoria, IL (US); Herbert Florey Martins DaCosta, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/219,730

(22) Filed: Jul. 28, 2008

(51) Int. Cl. B01D 53/86; G05D 99/00; F01N 3/01

(52) U.S. Cl. 204/157.3; 422/178; 422/105; 422/112; 422/116; 60/275

(57) ABSTRACT

An aspect of the present disclosure is directed to a system for removing particulate matter from an exhaust stream. The system may include an ionization device configured to ionize particles of an exhaust stream. The system may further include an electromagnetic field generating device configured to deflect the ionized particles onto an inner-surface of an exhaust passageway, the inner-surface of the exhaust passageway being coated with a substance for lowering activation energy for a reaction of the ionized particles. The system may further include a regeneration means configured to remove particles from the exhaust passageway.

### TECHNICAL FIELD

The present disclosure relates generally to exhaust treatment systems, and, more particularly, to exhaust treatment systems for removing particulate matter from exhaust streams.

### BACKGROUND

Typically, engines, including diesel engines, gasoline engines, gaseous fuel-driven engines, and other engines known in the art, emit a complex mixture of chemical species from their exhaust streams. These emissions may include particulate matter such as, for example, soot, soluble organic fraction (SOF), sulfates, and ash. Heightened environmental concerns have led regulatory agencies to implement more stringent emission standards for such engines, forcing engine manufacturers to develop systems to reduce levels of engine emissions.

In current diesel engine emission reduction systems, a diesel particulate filter (DPF) may be used to remove diesel particulate matter from an exhaust stream. The accumulation of particulate matter in the DPF may inhibit air flow from the engine through the exhaust stream, which may negatively affect engine efficiency. In order to remove particulate matter so that adequate airflow may be maintained, some emission reduction systems may include a regeneration device which removes particulate matter using a combustion process. The temperature required to combust the soot and the SOF in the particulate matter may be as high as 500-600 degrees Celsius. It may be undesirably expensive to supply the power required to introduce such a high temperature into a machine's exhaust system. Additionally, introducing such a high temperature into an exhaust system may lead to damage of exhaust system components such as, for example, the passageway of the exhaust system. Consequently, a system and method to lower the combustion temperature of the soot and the SOF in exhaust streams may be desirable.

One method for reducing the combustion temperature of the soot and the SOF in exhaust streams is disclosed in U.S. Pat. No. 5,402,639 (the '639 patent), issued to Fleck. Specifically, the '639 patent discloses a system in which exhaust gasses are passed through a channel of a ceramic body where an electric field is generated. The electric field causes soot particles to be deposited onto the walls of the channel, where they are oxidized by free ions or ions adhering to oxygen. The '639 patent further discloses that an air-carried oxidation catalyst may be introduced into the system as a function of the temperature of the exhaust system. The introduction of the air-carried oxidation catalyst may facilitate more rapid oxidation/reduction reactions. The oxidation of the soot particles by free ions or ions adhering to oxygen, and the introduction of the air-carried oxidation catalyst, may reduce the combustion temperature of the soot and the SOF particles.

Although the system of the '639 patent may reduce the combustion temperature of the soot and the SOF particles from an exhaust stream, the system of the '639 patent may be inefficient in certain situations. For example, injection of an aerosol oxidation catalyst into the exhaust stream may require an on-board reservoir to store a supply of the oxidation catalyst. The reservoir will eventually deplete, and will have to be periodically refilled. The depletion and refilling of the reservoir may increase maintenance down-time and maintenance costs of a machine.

The disclosed system is directed towards improving existing systems and methods of removing particulate matter from exhaust streams.

### SUMMARY

An aspect of the present disclosure is directed to a system for removing particulate matter from an exhaust stream. The system may include an ionization device configured to ionize particles of an exhaust stream. The system may further include an electromagnetic field generating device configured to deflect the ionized particles onto an inner-surface of an exhaust passageway, the inner-surface of the exhaust passageway being coated with a substance for lowering activation energy for a reaction of the ionized particles. The system may further include a regeneration means configured to remove particles from the exhaust passageway.

Another aspect of the present disclosure is directed to a method for removing particulate matter from an exhaust stream. The method may include ionizing particles of an exhaust stream. The method may further include deflecting the ionized particles onto an inner-surface of an exhaust passageway, the inner-surface of the exhaust passageway being coated with a substance for lowering activation energy of the ionized particles. The method may further include removing particles from the exhaust passageway through combustion.

Another aspect of the present disclosure is directed to a machine configured to remove particulate matter from an exhaust stream. The machine may include an engine configured to produce an exhaust stream. The machine may further include an ionization device configured to ionize particles in the exhaust stream. The machine may further include an electromagnetic field generating device configured to deflect the ionized particles onto an inner-surface of an exhaust passageway, wherein the inner-surface of the exhaust passageway is coated with a substance for lowering activation energy of the ionized particles. The machine may further include a regeneration device configured to remove particles from the exhaust passageway. The machine may further include a sensor configured to detect and generate a signal corresponding to a pressure associated with the exhaust stream. The machine may further include a controller configured to receive the generated signal and, based on the received signal, determine a period of time for activating the regeneration device.

### BRIEF DESCRIPTION OF THE DRAWINGS

FIG. 1 is a diagrammatic illustration of a machine according to exemplary disclosed embodiments;

FIG. 2 is a diagrammatic illustration of a portion of an exhaust system associated with the machine of FIG. 1; and

FIG. 3 is a flowchart illustrating an exemplary method for removing hydrocarbon particulate and ash from an exhaust stream.

### DETAILED DESCRIPTION

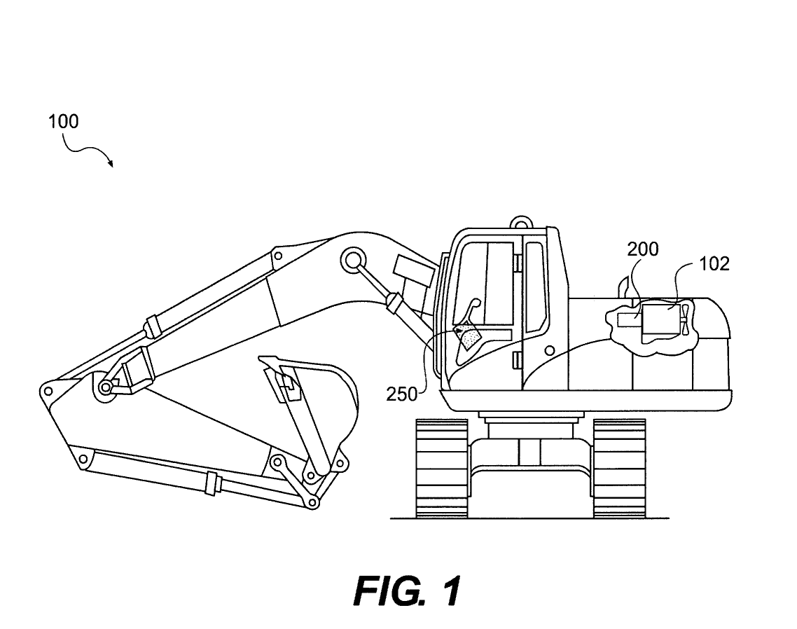

FIG. 1 illustrates an exemplary machine 100. Machine 100 may be any type of machine that performs some type of operation associated with an industry such as mining, construction, farming, transportation, etc. For example, machine 100 may be an earth moving machine such as an excavator, a dozer, a loader, a backhoe, or a tractor. Additionally, although FIG. 1 illustrates machine 100 as being a mobile earth-moving machine, it is contemplated that machine 100 may be other types of machines such as, for example, a mobile or stationary generator. Indeed, any type of machine or system that emits hydrocarbon particulate from an exhaust stream may employ the disclosed embodiments and their equivalents.

As illustrated in FIG. 1, machine 100 may include an engine 102 and an exhaust treatment system 200. Engine 102 may include at least one power-producing device configured to output mechanical energy. In one example, engine 102 may be an internal combustion engine having multiple sub-systems that cooperate to produce a mechanical power output. One skilled in the art will recognize that engine 102 may be any suitable power producing device such as, for example, a gasoline or diesel-powered engine. Engine 102 sub-systems may include, for example, a fuel system, an air induction system, an exhaust system, a lubrication system, a cooling system, and/or any other appropriate system(s).

Over time, particulate matter from an exhaust stream of engine 102 may accumulate and clog an exhaust system associated with machine 100. The accumulation of the particulate matter may impede air flow from the engine through the exhaust stream, which may negatively affect engine 102 efficiency. Therefore, exhaust treatment system 200 may remove hydrocarbon particulate and ash from an exhaust stream of machine 100 by first ionizing the organic components of the hydrocarbon particulate in the exhaust stream (i.e., the soot and the soluble organic fraction (SOF)). Exhaust treatment system 200 may then direct the ionized particulate to an activated catalyst surface (e.g., a catalyzed inner-surface of an exhaust passageway) under the influence of an electromagnetic field. Those familiar with the art will appreciate that the activated catalyst surface may result in the lowering of the activation energy of particulate matter in the exhaust stream.

As an effect of the lower activation energy of the particulate matter, a more rapid oxidation/reduction reaction will occur. The lowering of the activation energy of the particulate matter will also reduce the combustion temperature of the soot to 300-400 degrees Celsius. Because the SOF molecules are smaller than the soot and do not have the high aromatic contents that are present in the soot, the combustion temperature of the SOF will be reduced even lower than the combustion temperature of the soot. Particulate matter may then be combusted from exhaust treatment system 200 via a regeneration means.

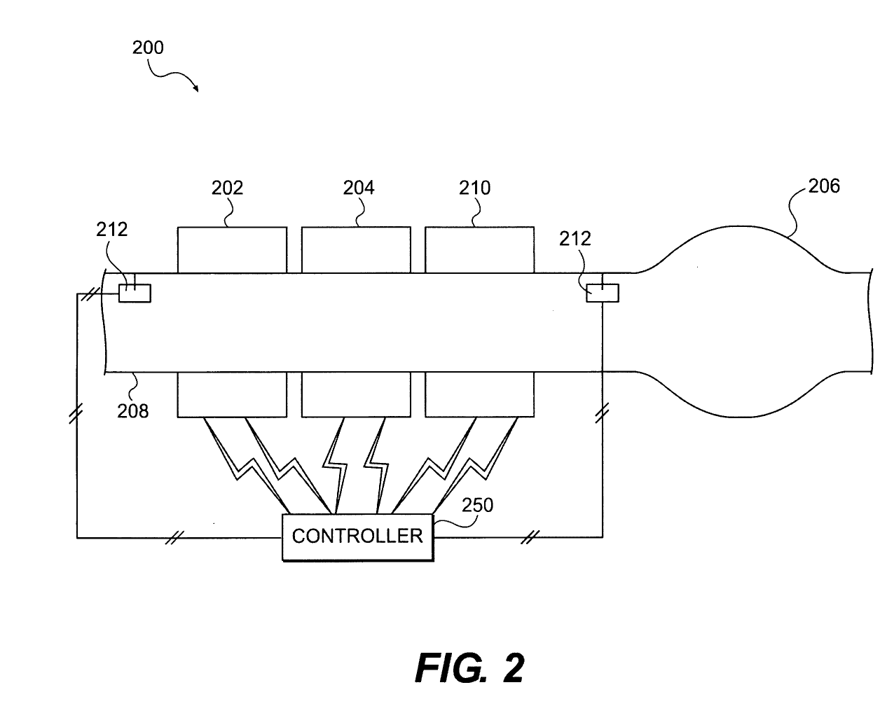

FIG. 2 shows an exemplary exhaust treatment system 200 which is illustrative of a portion of an exhaust system that may be associated with machine 100. As illustrated in FIG. 2, exhaust treatment system 200 includes one or more components and sub-systems that cooperate to remove hydrocarbon particulate and ash from an exhaust stream, consistent with the disclosed embodiments and their equivalents. Exhaust treatment system 200 may include an ionizer 202, an electromagnetic field (EMF) generating device 204, and a filter 206, all coupled by an exhaust passageway 208.

Ionizer 202 may be located upstream of EMF generating device 204, and comprises any device configured to ionize organic components (i.e., soot and SOF) of an exhaust stream by adding or removing charged particles such as, for example, electrons. As an example, ionizer 202 may use a suitable electric process to release ions or molecular fragments into the surrounding air. The ions may then attach to the soot and the SOF, thereby ionizing the soot and the SOF. In one embodiment, the suitable electric process may consist of using a low power voltage to electrically charge molecules of air. As an example, electrically charged plates may be used to produce negative ions that the particulate matter may stick to. It is contemplated that ionizer 202 may employ a pulse or beam technique as desired. For example, in limited power situations, ionizer 202 may periodically ionize the soot and SOF (i.e., ionizer 202 may employ a pulse technique). Conversely, if enough power is available, ionizer 202 may continuously ionize the soot and the SOF (i.e., ionizer 202 may employ a beam technique).

EMF generating device 204 may be located proximate to ionizer 202. EMF generating device 204 comprises any device configured to generate an electric field in a direction perpendicular to the inner-surface of the exhaust passageway 208. Thus, as particles pass through exhaust passageway 208, ionized particles will be deflected in the direction of the electric field (i.e., toward the inner-surface of the exhaust passageway 208). In one embodiment, EMF generating device 204 may include an electrode suitably located within exhaust passageway 208. In another embodiment, EMF generating device 204 may include a conductive material (not shown) which encompasses exhaust passageway 208. The conductive material may be wound around exhaust passageway 208 as a continuous coil. The conductive material may be any type of material that allows electrical current to pass through it, such as, for example, copper or aluminum. As electrical current passes through the conductive material, an electromagnetic field will be produced, which will cause ionized particles of an exhaust stream of engine 102 to be deflected toward the inner-surface of the exhaust passageway 208. The description of EMF generating device 204 is not intended to be limiting. Indeed, any device configured to generate an electric field in a direction perpendicular to the inner-surface of the exhaust passageway 208 may be used.

Filter 206 may be located downstream of ionizer 202 and EMF generating device 204. Filter 206 may be configured to trap particulate matter that is not deflected onto the inner-surface of the exhaust passageway 208 by EMF generating device 204. Filter 206 may be any suitable filter such as, for example, a diesel particulate filter (DPF), a continuously regenerating trap, a catalyzed continuously regenerating trap, or another suitable device configured to prevent particulate matter from leaving exhaust treatment system 200. Alternative embodiments of exhaust treatment system 200 may have filter 206 located in other locations, such as, for example, upstream from ionizer 202, or proximate to exhaust passageway 208.

Again, exhaust passageway 208 may be located downstream from engine 102. Exhaust passageway 208 may comprise any suitable material such as, for example, ceramic, steel, stainless steel, etc. The inner-surface of exhaust passageway 208 may be coated with a substance configured to lower the activation energy of particulate matter that comes into contact with the substance. The substance may include precious and/or non-precious metals such as, for example, aluminum, platinum, palladium, rhodium, gold, silver, etc. One familiar with the art will appreciate that as particulate matter comes into contact with the surface of the substrate, the activation energy of particulate matter will be lowered. As a result of the lower activation energy, more rapid oxidation/reduction reaction(s) will occur. Examples of the resulting oxidation/reduction reaction(s) that may occur are detailed in Table 1 below.

TABLE 1
Oxidation/Reduction Catalyst

2NOₓ → xO₂ + N₂
2CO + O₂ → 2CO₂
2CₓH_{y} + (2x + y/2)O₂ → 2xCO₂ + yH₂O

The last step also includes a partial oxidation step that produces CO and H2O. CO is however later oxidized to CO2 yielding CO2 and H2O as the final product.

The lowering of the activation energy will also reduce the combustion temperature of the soot to 300-400 degrees Celsius. Because the SOF molecules are smaller than the soot and do not have the high aromatic contents that are present in the soot, the combustion temperature of the SOF will be reduced even lower than the combustion temperature of the soot.

A regeneration means may be used to combust particulate matter from exhaust treatment system 200. For example, in certain embodiments, the exhaust gas flow through exhaust treatment system 200 may result in the inner-surface of exhaust passageway 208 having a temperature that is high enough to combust the soot and the SOF. As an example, after the deflected ionized particles go through their oxidation/reduction reactions, the lowering of the activation energy in combination with the temperature of the inner-surface of exhaust passageway 208, may result in the combustion of the soot and the SOF from the inner-surface of exhaust passageway 208 by the heat stored on the inner-surface of exhaust passageway 208. That is, the soot and the SOF that are located on the inner-surface of exhaust passageway 208 may be combusted by the temperature of the inner-surface of exhaust passageway 208. Thus, in this embodiment, the sufficiently heated inner-surface of exhaust passageway 208 acts as the regeneration means.

According to other embodiments, the regeneration means in exhaust treatment system 200 may include a regeneration device 210 configured to raise the temperature within exhaust treatment system 200 so that at least some of the particulate matter accumulated in exhaust treatment system 200 may be combusted. Regeneration device 210 may include, for example, a flame-producing burner, a heating element, or any other suitable device configured to raise the temperature within exhaust treatment system 200 so as to induce a combustion reaction of particulate matter.

Exhaust treatment system 200 may further include sensors 212 configured to monitor information indicative of the status of exhaust treatment system 200. For example, sensors 212 may be configured to monitor parameters indicative of the temperatures, pressures, and/or flow rates associated with exhaust treatment system 200. Sensors 212 may further be configured to generate signals corresponding to the monitored parameters, and transit the generated signals to a controller 250 associated with machine 100. Controller 250 may use the monitored parameters to, for example, indicate when and for how long regeneration device 210 should be activated.

As an example, as sensors 212 monitor exhaust treatment system 200, one or more of sensors 212 may detect exhaust gasses originating from engine 102 being directed to exhaust treatment system 200. In response to the detection, the one or more of sensors 212 may generate and transmit a signal to controller 250 indicating that exhaust gasses originating from engine 102 are being directed to exhaust treatment system 200. In this example, controller 250 will forward the transmitted signal to one or more appropriate control modules located within controller 250. The control module(s) may process the received signal, and further signal engine 102 to supply power to ionizer 202 and EMF generating device 204. Consequently, ionizer 202 and EMF generating device 204 will be activated, and, as a result, the organic components of the exhaust gasses of machine 100 will be ionized and deflected onto the catalyzed inner-surface of the exhaust passageway 208. On the inner-surface of exhaust passageway 208, a catalytic reaction may occur, thereby reducing the soot and the SOF combustion temperatures.

Continuing with this example, as exhaust gasses of machine 100 flow through exhaust treatment system 200, one or more of sensors 212 may detect particulate matter accumulation in exhaust treatment system 200. In response to the detection of the accumulation of particulate matter, the one or more of sensors 212 may generate and transmit a signal to controller 250 indicating that particulate matter has accumulated in exhaust treatment system 200. In one embodiment, the generated and transmitted signal may be indicative of a pressure associated with engine 102 and/or exhaust treatment system 200. Controller 250 may receive the transmitted signal, and forward the signal to one or more appropriate control modules located within controller 250 for processing. The control module(s) may process the received signal, and signal the engine 102 to supply power to regeneration device 210. Consequently, regeneration device 210 will be activated, and, as a result, accumulated particulate matter will be combusted from exhaust treatment system 200.

In order to accomplish its programmed tasks, controller 250 may include one or more processing devices (not shown), and memory devices for storing data executed by the processing devices (not shown). In one embodiment, controller 250 may include software that is stored in a rewritable memory device, such as a flash memory. The software may be used by a processing device to control exhaust treatment system 200.

Controller 250 may further include one or more computer mapping systems in a memory of controller 250. Such computer mapping systems may include tables, graphs, and/or equations. The computer mapping systems may relate to desired power to be supplied to ionizer 202 and EMF generating device 204, desired temperatures associated with regeneration device 210 and exhaust treatment system 200, desired limits on particulate matter accumulation in exhaust treatment system 200, and/or other suitable information relating to the operation of exhaust treatment system 200. It is contemplated that an operator of machine 100 may modify these computer mapping systems and/or select specific maps from available relationship maps stored in memory. In one example, the maps may additionally or alternatively be automatically selectable based on modes of machine 100 operation.

In one embodiment, the signals originating from sensors 212 may be compared to threshold values or threshold ranges in the computer mapping system of controller 250, and, as a result of the comparison, desired action may be taken. As an example, as exhaust gasses of machine 100 travel through exhaust treatment system 200, one or more of sensors 212 may detect and generate signals indicative of a volume of particulate matter accumulation in exhaust treatment system 200. In one embodiment, the signals may relate to a pressure associated with exhaust treatment system 200 and/or engine 102. Sensors 212 may transmit the detected and generated signals to controller 250, where information indicative of the signals may be compared to threshold ranges or threshold values in a computer memory of controller 250. If, based on the comparison, it is determined that the volume of particulate matter accumulation in exhaust treatment system 200 is above a threshold value (or a threshold range), regeneration device 210 may be activated for a first determined amount of time.

Conversely, if, based on the comparison, it is determined that the volume of particulate matter accumulation in exhaust treatment system 200 is below a threshold value (or a threshold range), regeneration device 210 may be activated for a second determined amount of time, which may be less than the first determined amount of time. In some embodiments, if it is determined that the volume of particulate matter accumulation in exhaust treatment system 200 is below a threshold value (or a threshold range) regeneration device 210 may not be activated.

It is contemplated that controller 250 may alert an operator of machine 100 to exhaust treatment system 200 characteristics. For example, an operator of machine 100 may be alerted to when and how long regeneration device 210 was activated, how much particulate matter has accumulated in exhaust treatment system 200, and/or any other suitable characteristics of machine 100 and exhaust treatment system 200. It is further contemplated that this and other information may be saved in a computer memory of controller 250 for later processing.

One skilled in the art will appreciate that controller 250 may contain additional and/or different components than those listed above. For example, controller 250 may include one or more other components or sub-systems such as, for example, power supply circuitry, signal conditioning circuitry, solenoid driver circuitry, and/or any other suitable circuitry for aiding in the control of one or more systems of machine 100.

It is further contemplated that exhaust treatment system 200 may include additional and/or different exhaust treatment devices disposed along exhaust passageway 208, if desired. For example, exhaust treatment system 200 may include a NOx trap, an exhaust gas recirculation cooler, a selective catalytic reduction device, and/or any other exhaust treatment device(s) known in the art. It is further contemplated that other configurations of exhaust treatment system 200 may be possible.

Although FIG. 1 illustrates a single exhaust treatment system 200 associated with engine 102, it is contemplated that more than one of exhaust treatment system 200 may be implemented on machine 100. For example, in one embodiment, machine 100 may have two exhaust pipes. In this embodiment, each exhaust pipe on machine 100 may be associated with a different exhaust treatment system 200.

### INDUSTRIAL APPLICABILITY

The disclosed system may be applicable to any combustion-type device, such as an engine, where a reduction in the combustion temperature of the soot and the SOF from an exhaust stream is desired. The reduction of the combustion temperature of the soot and the SOF may allow for reduced power requirements associated with the regeneration of the soot and the SOF. Additionally, the reduction of the combustion temperature of the soot and the SOF may further ensure that exhaust treatment systems are not damaged by excessive heat associated with combustion processes.

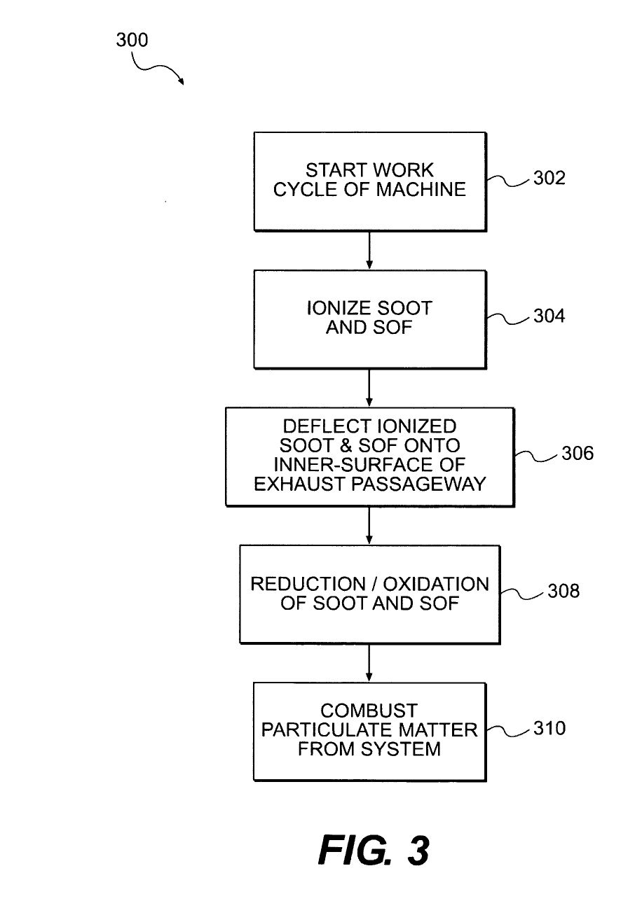

FIG. 3 shows a flowchart 300 illustrating a process for reducing pollutants/chemical species from an exhaust stream consistent with the disclosed embodiments and their equivalents. Flowchart 300 includes an operator starting the work cycle of machine 100 (Step 302). As a function of the work cycle of machine 100, exhaust gas flow may be directed through exhaust treatment system 200. As the particulate matter enters exhaust treatment system 200, the soot and the SOF of the exhaust gas flow may be ionized due to ionizer 202 adding charged particles to, or removing charged particles from, the soot and the SOF (Step 304). As an example, ionizer 202 may use one or more electrodes to release ions into the surrounding air. The ions may then attach to the soot and the SOF, thereby ionizing the soot and the SOF.

The ionized particles may then pass through an electric field created by EMF generating device 204. The electric field will deflect the ionized soot and SOF onto the inner-surface of exhaust passageway 208 (Step 306). The inner-surface of exhaust-passageway 208 may be coated with any suitable material to facilitate oxidation and reduction reactions. Non-limiting examples of suitable coating material includes precious and/or non-precious metals such as, for example, aluminum, platinum, palladium, rhodium, gold, silver, etc. As the ionized soot and SOF are deflected onto the catalyzed inner-surface of the exhaust passageway 208, a resulting oxidation/reduction reaction will occur (Step 308). Non-limiting examples of oxidation/reduction reactions include, for example, the reduction of nitrogen oxides to nitrogen and oxygen, the oxidation of carbon monoxide to carbon dioxide, and/or the oxidation of “unburnt” hydrocarbons to carbon dioxide and water. Again, the resulting oxidation/reduction catalyst will lower the activation energy of the soot and the SOF. The lowering of the activation energy will reduce the combustion temperature of the soot to 300-400 degrees Celsius. Because the SOF molecules are smaller and do not have the high aromatic contents that are present in the soot, the combustion temperature of the SOF will be reduced even lower than the combustion temperature of the soot.

As particulate matter accumulates in exhaust treatment system 200, thereby affecting engine 102 performance, the accumulated particulate matter may be combusted from exhaust treatment system 200. (Step 310). The accumulated particulate matter may be combusted from exhaust treatment system 200 in any suitable manner. In one embodiment, a heater embedded in exhaust treatment system 200 may be used to raise the temperature of the particulate matter in exhaust treatment system 200. In another embodiment, the temperature of exhaust gasses in exhaust treatment system 200 may be increased when combustion is desired. In some embodiments, the normal operating temperature of the exhaust gasses in exhaust treatment system 200 may be sufficient to combust the particulate matter in exhaust treatment system 200.

Additionally, certain embodiments of the present disclosure may include alerting an operator to the status of exhaust treatment system 200. For example, it is contemplated that an alert may be provided to the operator of machine 100 indicating the time and duration that regeneration device 210 was activated, how much particulate matter has accumulated in exhaust treatment system 200, and/or any other suitable characteristics of machine 100 and exhaust treatment system 200.

Those familiar with the art will appreciate that the steps in flowchart 300 may be implemented in any suitable manner. For example, it is contemplated that the steps in flowchart 300 may be implemented continuously, periodically, individually repeated, etc. As an example, it is contemplated that ionizer 202 and EMF generating device 204 may continuously ionize and deflect particulate matter in exhaust treatment system 200 while regeneration device 210 periodically combusts particulate matter from exhaust treatment system 200.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims.

What is claimed is:

1. A system for removing particulate matter from an exhaust stream, comprising:
an ionization device configured to ionize particles of an exhaust stream;
an electromagnetic field generating device configured to deflect the ionized particles onto an inner-surface of an exhaust passageway, the inner-surface of the exhaust passageway being coated with a substance for lowering activation energy for a reaction of the ionized particles; and
a regeneration means configured to remove particles from the exhaust passageway.

2. The system of claim 1, further including a sensor configured to:
detect information indicative of an amount of accumulated particles in the exhaust passageway; and
generate a signal corresponding to the detected information, wherein if the regeneration means is a regeneration device, the regeneration device is configured to remove particles from the exhaust passageway in response to the generated signal.

3. The system of claim 2, wherein the detected information is indicative of a pressure associated with the exhaust stream.

4. The system of claim 2, further including a controller configured to receive the generated signal, and, based on the received signal, determine a period of time for activating the regeneration device.

5. The system of claim 4, wherein the controller is further configured to compare information indicative of the received signal to a threshold value, and, based on the comparison, determine the period of time for activating the regeneration device.

6. The system of claim 2, wherein the regeneration device is configured to remove particles from the exhaust passageway by thermally combusting particles.

7. The system of claim 1, wherein the substance comprises a precious metal.

8. The system of claim 1, wherein the substance comprises a non-precious metal.

9. The system of claim 1, wherein the exhaust passageway comprises one or more of ceramic, steel, and stainless steel.

10. A method for removing particulate matter from an exhaust stream, comprising:
ionizing particles of an exhaust stream;
deflecting the ionized particles onto an inner-surface of an exhaust passageway, the inner-surface of the exhaust passageway being coated with a substance for lowering activation energy of the ionized particles; and
removing particles from the exhaust passageway through combustion.

11. The method of claim 10, further including:
detecting information corresponding to an amount of accumulated particles in the exhaust passageway; and
generating a signal indicative of the detected information.

12. The method of claim 11, wherein detecting information corresponding to an amount of accumulated particles in the exhaust passageway includes detecting information corresponding to a pressure associated with the exhaust stream.

13. The method of claim 11, further including comparing information indicative of the generated signal to a threshold value, and, based on the comparison, determining a period of time for activating a regeneration device.

14. The method of claim 13, wherein determining the period of time for activating the regeneration device includes determining a period of time for activating a regeneration device that is configured to remove particles from the exhaust passageway by thermally combusting particles.

15. The method of claim 10, wherein the substance is one or both of a precious metal and a non-precious metal.

16. A machine configured to remove particulate matter from an exhaust stream, comprising:
an engine configured to produce an exhaust stream;
an ionization device configured to ionize particles in the exhaust stream;
an electromagnetic field generating device configured to deflect the ionized particles onto an inner-surface of an exhaust passageway, wherein the inner-surface of the exhaust passageway is coated with a substance for lowering activation energy of the ionized particles;
a regeneration device configured to remove particles from the exhaust passageway;
a sensor configured to detect and generate a signal corresponding to a pressure associated with the exhaust stream; and
a controller configured to receive the generated signal and, based on the received signal, determine a period of time for activating the regeneration device.

17. The machine of claim 16, wherein the regeneration device is configured to remove particles from the exhaust passageway by thermally combusting particles.

18. The machine of claim 16, wherein the electromagnetic field generating device is comprised of at least one electrode built into the exhaust passageway.

19. The machine of claim 16, wherein the substance comprises one or both of a precious metal and a non-precious metal.

20. The machine of claim 16, wherein the exhaust passageway comprises one or more of ceramic, steel, and stainless steel.
